(19) United States
(12) Patent Application Publication
(10) Pub. No.: US 2021/0248439 A1
(43) Pub. Date: Aug. 12, 2021

(54) METHOD AND APPARATUS FOR RFID AUTHENTICATION

(71) Applicant: eAgile Incorporated, Grand Rapids, MI (US)

(72) Inventors: Michael Isabell, Grand Rapids, MI (US); Gary P. Burns, Rockford, MI (US); Joseph Paul Skripka, Rockford, MI (US)

(73) Assignee: eAgile Incorporated, Grand Rapids, MI (US)

(21) Appl. No.: 17/049,149

(22) PCT Filed: Apr. 25, 2018
(86) PCT No.: PCT/US2018/044380

§ 371 Date: Oct. 20, 2020

Related U.S. Application Data
(60) Provisional application No. 62/662,703, filed on Apr. 25, 2018.

(51) Int. Cl. G06K 19/07; H04L 9/06; H04L 9/32

(52) U.S. Cl. CPC G06K 19/0723; H04L 2209/805; H04L 9/3271; H04L 9/0656

(57) ABSTRACT

A method and apparatus for authenticating a radio frequency identification (RFID) tag (10) includes providing an RFID tag (10) having a tag ID (40) and a pseudo-ID (42), receiving the tag ID (40) and the pseudo-ID (42) from the RFID tag (10), and applying at least one algorithm (21, 22, 25, 30) of a set of algorithms (20, 30) to one of the tag ID (40) and the pseudo-ID (42) to generate a decoded ID (44, 44A, 44B).

### CROSS REFERENCE TO RELATED APPLICATION(S)

This application claims the benefit of U.S. Provisional Application Ser. No. 62/662,703 filed Apr. 25, 2018, which is incorporated herein by reference in its entirety.

### BACKGROUND

Radio-frequency identification (RFID) technology can be utilized for identifying and tracking items of interest along a supply chain. For example, RFID inlays or tags can be prepared, encoded, and incorporated with product units to identify each product unit while it is stored, handled, transported, or utilized.

It can be beneficial to verify that an RFID inlay or tag has been correctly coded or is otherwise authentic, so as to authenticate identification of the associated product unit.

### BRIEF DESCRIPTION

In one aspect, the disclosure relates to a method for authenticating a radio frequency identification (RFID) tag. The method includes providing an RFID tag having a tag ID and a pseudo-ID, wherein the pseudo-ID is related to the tag ID by at least one algorithm in a set of algorithms. The method further includes receiving, in an RFID reader, the tag ID and the pseudo-ID from the RFID tag, applying, via a processor in the RFID reader, at least one algorithm of the set of algorithms to one of the tag ID and the pseudo-ID to generate a decoded ID, and comparing, in the RFID reader, the decoded ID with the one of the tag ID and the pseudo-ID. If the decoded ID matches the one of the tag ID and the pseudo-ID, the RFID tag is deemed authentic. If the decoded ID does not match the one of the tag ID and the pseudo-ID, then the RFID tag is deemed not authentic.

In another aspect, the disclosure relates to a system for authenticating a radio frequency identification (RFID) tag. The system includes an RFID tag having a programmable memory and a non-programmable memory, a tag ID stored in the non-programmable memory, a pseudo-ID stored in the programmable memory, wherein the pseudo-ID is related to the tag ID by a set of algorithms, and an RFID reader. The RFID reader can include a memory, the set of algorithms stored in the memory, an input module configured to receive the tag ID and the pseudo-ID from the RFID tag, a processor configured to generate a decoded ID via the set of algorithms, and a comparison module configured to compare the decoded ID with one of the tag ID and the pseudo-ID.

### BRIEF DESCRIPTION OF THE DRAWINGS

In the drawings:

FIG. 1 is a schematic view of an authentication system including an exemplary RFID tag and an exemplary RFID reader according to various aspects described herein.

FIG. 2 is a schematic view of a memory in the RFID reader of FIG. 1 according to various aspects described herein.

FIG. 3 is a schematic view of a portion of the RFID reader of FIG. 1 according to various aspects described herein.

FIG. 4 is a flowchart illustrating a method of generating a pseudo-ID for the RFID tag of FIG. 1.

FIG. 5 is a flowchart illustrating a method of authenticating an RFID tag in the authentication system of FIG. 1.

FIG. 6 is a flowchart illustrating another method of authenticating an RFID tag in the authentication system of FIG. 1.

### DETAILED DESCRIPTION

Radio-frequency identification (RFID) tags can be coupled to a diverse range of objects for identification and other purposes. Such tags can be utilized in logistics, track and trace, chain of custody, retail settings, or healthcare settings, in non-limiting examples. There can be a risk of counterfeit RFID tags entering a supply chain, such as in certain settings that may implement a predictable method of numbering RFID tags. The described aspects of the present disclosure are directed to a method and apparatus for authenticating an RFID tag. It will be understood that the disclosure can have general applicability in a variety of industrial, commercial, and residential applications as desired.

Radio-frequency identification can be accomplished over a variety of frequencies and with a variety of communication protocols. For example, near-field communication (NFC) can enable devices within close proximity to each other (for example, within 5 cm) to establish communication. Other standards include industrial, scientific, and medical (ISM) bands such as 13 MHz, or ultra-wide-band communication such as 4 GHz. RFID tags can have a range of physical sizes, such as 0.05 mm to 5 cm or larger, and configurations such as active, passive, or battery-assisted passive, for use in the various frequency bands and communication protocols.

In various settings there is a need to apply RFID tags to diverse objects. In some cases a tag ID may or may not be encoded correctly or a tag ID may have been intentionally duplicated or miscoded in order to produce a counterfeit tagged product. Brand owners protect their brand by authenticating their products through the entire supply chain, including in some cases to the end consumer. In order to track product through the supply chain, the tag ID is utilized and thus is made known to various entities. As such, the tag ID may be duplicated along with a counterfeit product (also known as “cloning” tags). For example, pharmaceutical products can be in the custody of one or more third-party entities, (separate from the brand owner, as the product moves through distribution and sale to the end consumer. The standardization of serialization formats can be used to the counterfeiters' advantage, as a single unique identifier (product tag ID or serialized barcode) can provide the basis for creating one or many duplicate identifiers (cloned tags) which could be inadvertently authenticated. Open communication standards have allowed for a more efficient supply chain by allowing various entities to openly share information, such as in the event of a product recall, and such open standards can also allow the facilitation of counterfeit duplication of RFID tags. In some cases, a counterfeit tag ID number can be erroneously validated by the brand owner.

Aspects described herein provide for a system that authenticates a given tag ID, validating that such a tag ID is correct and not simply a duplication of an existing valid Tag ID gained through access to the supply chain. Further, aspects described herein provide that require access to a database to validate authenticity. When a tagged product must authenticated there may or may not be a method to transmit the Tag ID to a database for validation (lack of internet access etc.). Further when there is a communication link available, there may not be enough time/access required for the Tag ID to be transmitted and/or the centralized “look up” time may be too long, or other barriers to authentication. Aspects of the disclosure provide for quick de-centralized authentication to a level that is a substantially improvement over the current systems. This system also allows for various more sophisticated algorithms that can provide various levels of security based on the client's needs.

While “a set of” various elements will be described, it will be understood that “a set” can include any number of the respective elements, including only one element. Also as used herein, while sensors can be described as “sensing” or “measuring” a respective value, sensing or measuring can include determining a value indicative of or related to the respective value, rather than directly sensing or measuring the value itself. The sensed or measured values can further be provided to additional components. For instance, the value can be provided to a controller module or processor, and the controller module or processor can perform processing on the value to determine a representative value or an electrical characteristic representative of said value.

As used herein, a “network” can include a set of components, processing systems, sensors, display module assemblies, or the like, interconnected to enable, provide for, or otherwise allow for communication transmitted between the respective components. The “network” can include communication lines, wires, cables, conductors, or the like, and can be connected directly with other components or connected by way of a communications hub, such as a network switch. Communications can include analog or digital signal transmission on a deterministic network adaptation or protocol, and are not germane to the disclosure. Also as used herein, a “remote” component is a component communicatively connected by way of the network relative to a referentially described component. Thus, a “remote” component is a component communicatively or physically spaced from the reference component; they are not components on a same assembly.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. In non-limiting examples, connections or disconnections can be selectively configured to provide, enable, disable, or the like, an electrical connection between respective elements.

As used herein, a “system” can include at least one processor and memory. Non-limiting examples of the memory can include Random Access Memory (RAM), Read-Only Memory (ROM), flash memory, or one or more different types of portable electronic memory, such as discs, DVDs, CD-ROMs, etc., or any suitable combination of these types of memory. The processor can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

The exemplary drawings are for purposes of illustration only and the dimensions, positions, order, and relative sizes reflected in the drawings attached hereto can vary.

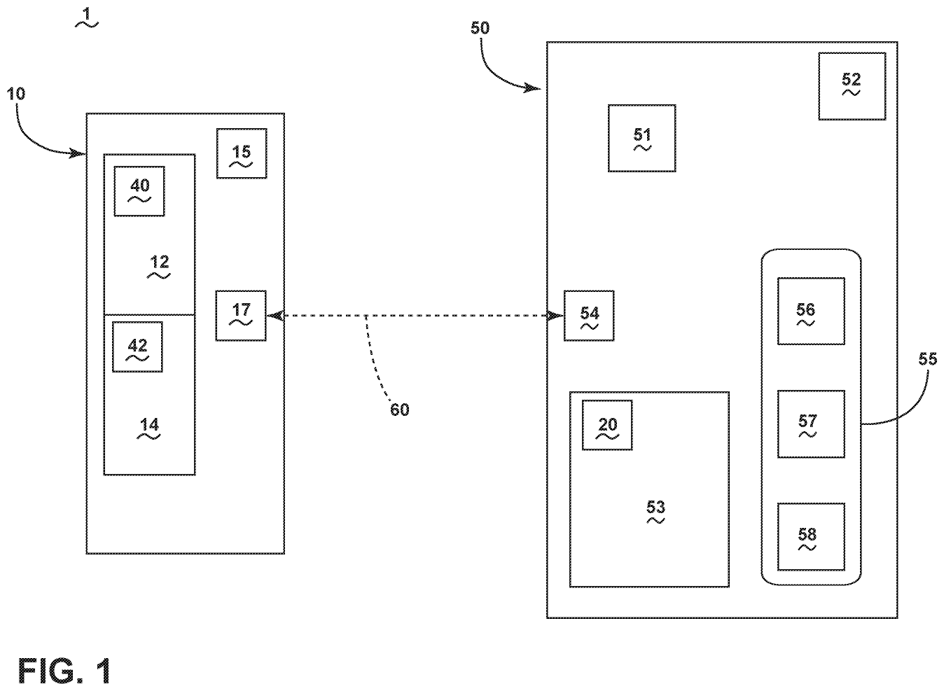

As illustrated in FIG. 1, a system 1 for authenticating a radio frequency identification tag (herein also referred to as an “authentication system” or “system” 1) is shown having a set of communicative components which are schematically represented by boxes. The system 1 can include an exemplary RFID tag 10 in signal communication with an exemplary RFID reader 50.

The RFID tag 10 can include a non-programmable memory 12, a programmable memory 14, a tag processor 15, and a tag antenna 17, each in electrical or signal communication with one another. During manufacture of the RFID tag 10, a unique identification number herein referred to as a “tag ID” 40 can be stored in the non-programmable memory 12 (also known as a “one-time-programmable” or “read-only” memory). It will be understood that such a non-programmable memory can be programmed to store data in a single instance, and that altering the stored data cannot be achieved after the initial input of data into the non-programmable memory 12. In addition, a pseudo-ID 42 related to the tag ID 40 can be stored in the programmable memory 14. Such a programmable memory can be configured to store, delete, or modify data already stored as desired. In non-limiting examples, the pseudo-ID 42 can be stored in the programmable memory 14 during manufacture of the RFID tag 10, at a downstream customer manufacturing or distribution center, or at an end point of sale as desired.

A set of algorithms 20 can be utilized to relate the pseudo-ID 42 to the tag ID 40. The set of algorithms 20 can include any desired algorithm such as a check digit, a key, a random number generator, a bit flipping function, or a checksum function, or the like, or combinations thereof.

In one non-limiting example, a portion of the pseudo-ID 42 can be derived from at least a portion of the tag ID 40 via the set of algorithms 20, thereby relating the pseudo-ID 42 to the tag ID 40. In another non-limiting example, the set of algorithms 20 can combine or merge a portion of the pseudo-ID 42 with a portion of the tag ID 40 to form a combined ID that can be compared with or match another aspect (such as a GPS location) associated with the RFID tag 10, thereby relating the pseudo-ID 42 to the tag ID 40. In still another non-limiting example, either or both of the pseudo-ID 42 or tag ID 40 can include a time-varying factor, where the set of algorithms 20 relates the pseudo-ID 42 and tag ID 40 at least by a specific time or timestamp.

The tag processor 15 can be in the form of an integrated circuit, microchip, microprocessor, or the like, and can include other components not explicitly illustrated such as power controllers or substrates. While illustrated schematically as distinct components, it is contemplated that either or both of the non-programmable memory 12 and programmable memory 14 can be included within the integrated circuit defining the tag processor 15. In addition, the tag antenna 17 can be configured to transmit or receive electromagnetic radiation in the form of radio waves for signal communication with other devices such as the RFID reader 50.

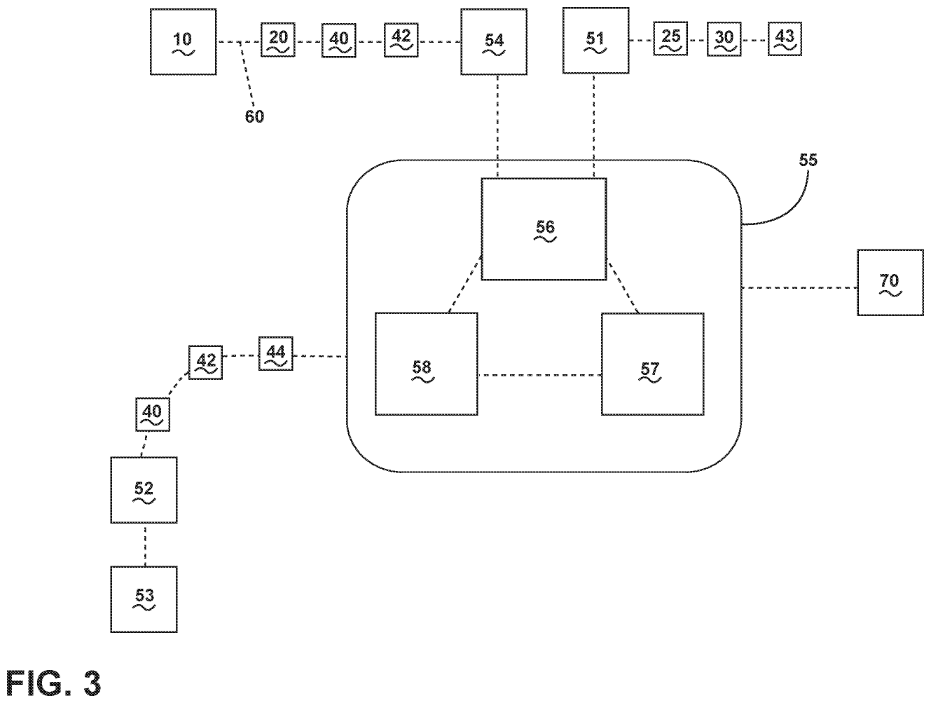

The RFID reader 50 is illustrated as including a user interface 51, a reader processor 52, a reader memory 53, a reader antenna 54, and a set of modules 55 including an input module 56, a selector module 57, and a comparison module 58. While illustrated as being located within the RFID reader 50, it is also contemplated that at least one of the user interface 51 and any in the set of modules, such as the selector module 57, can be located in a remote device 70 (FIG. 3) such as an external computer, server, database, or mobile device and in signal communication with the RFID reader 50. For example, the RFID reader 50 can optionally be networked with such a remote device 70.

The reader antenna 54 can be configured to transmit or receive radio waves. An arrow represents a signal communication 60 between the RFID reader 50 and the RFID tag 10, where the tag ID 40 and the pseudo-ID 42 can be received by the reader antenna 54 from the RFID tag 10. Though illustrated as discrete components, it is further contemplated that the reader antenna 54 can also be included within, or integrated with, the input module 56.

The user interface 51 can be utilized to receive input from, or present information to, a user. It is also contemplated that the user interface 51 can be integrated with the input module 56 as desired. The user interface 51 can include a display screen or touchscreen, keyboard, audio module or speaker, haptic feedback generator such as a vibrating motor, buttons, switches, selector knobs, or a wired or wireless interface with another device such as a computer or mobile device, in non-limiting examples.

The selector module 57 can be utilized, alone or in concert with the user interface 51, to select at least one algorithm from the set of algorithms 20 in the reader memory 53. The reader memory 53 can be of any desired type, including a programmable memory, or volatile or non-volatile memory as desired. In addition, the reader processor 52 can be configured to receive or send signals to and from the user interface 51, the selector module 57, the reader memory 53, and the reader antenna 54.

The reader processor 52 can be configured to generate a pseudo-ID based on an algorithm in the set of algorithms 20. For example, the RFID tag 10 can include the pseudo-ID 42, and the reader processor 52 can be configured to generate an additional pseudo-ID 43 based on at least one algorithm in the set 20. The reader processor 52 can also store the additional pseudo-ID 43 in the programmable memory 14 of the RFID tag 10 as desired, including deleting the pseudo-ID 42 and replacing with the additional pseudo-ID 43.

The comparison module 58 can be configured to compare data including, but not limited to, the tag ID 40 and the pseudo-ID 42. The comparison module 58 can also provide an indication of a comparison result, such as “Match,” “No Match,” “Verified,” “Not Verified,” “Authentic,” “Non-authentic,” and the like. Such an indication can be provided to the user interface 51, and can include a visual indication, audio indication, or haptic or tactile indication as desired. The comparison module 58 can also be in signal communication with the reader processor 52, or be integrated with the reader processor 52 as desired.

It will be understood that the illustrated aspect of the disclosure of FIG. 1 is only one non-limiting schematic example of an authentication system, and many other possible aspects and configurations in addition to that shown are contemplated by the present disclosure. In addition, the number and placement of the various components depicted in FIG. 1 are also non-limiting examples of aspects associated with the disclosure. Furthermore, while the components of the RFID tag 10 and the RFID reader 50 are illustrated as separate or discrete components separated from one another, additional or alternative aspects can be included wherein, for example, at least a subset of the components can be combined into an integrated component or module. For example, the user interface 51, the reader processor 52, and the reader memory 53 can be combined into a unitary module or component.

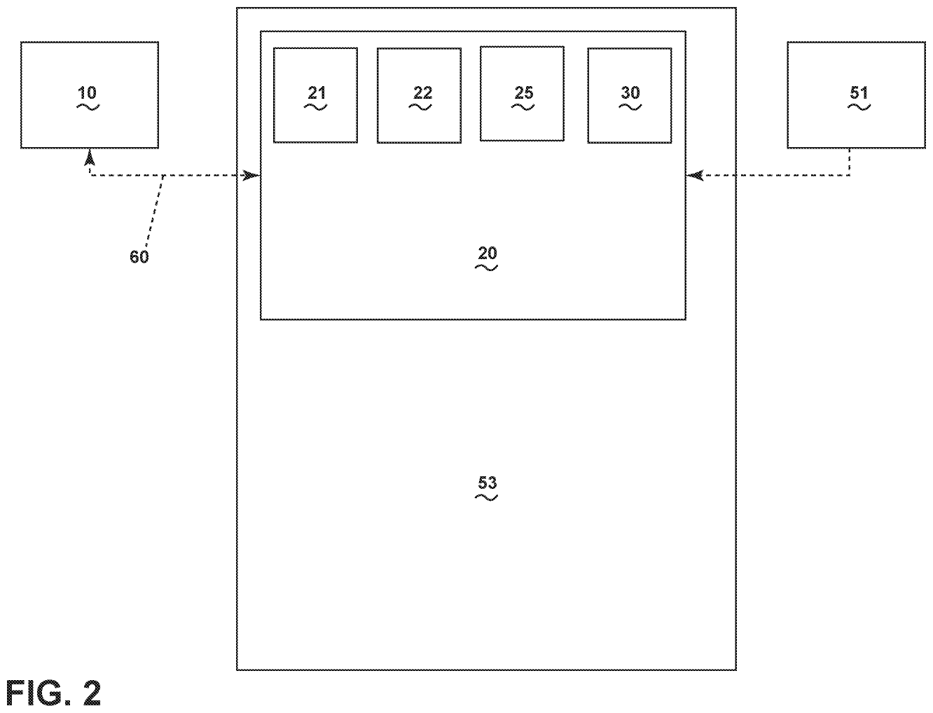

Turning to FIG. 2, the reader memory 53 is illustrated in further detail. The set of algorithms 20 relating the tag ID 40 to the pseudo-ID 42 can be stored in the reader memory 53. It is further contemplated that more than one algorithm can relate the tag ID 40 to the pseudo-ID 42. For example, a first algorithm 21 can include a bit flipping function and a second algorithm 22 can include a check digit, where the pseudo-ID relates to the tag ID by both algorithms 21, 22. In another non-limiting example where the tag ID relates to the pseudo-ID by multiple algorithms, an active algorithm 25 out of the set of algorithms 20 can be selected for use in authenticating the RFID tag 10. In such a case, a user can select the active algorithm 25 via the user interface 51 as desired.

It is further contemplated that a user may desire to update an algorithm utilized for authenticating the RFID tag 10. In such a case, at least one additional algorithm 30 can be added to the set of algorithms 20, for example via the user interface 51 receiving the at least one additional algorithm 30. The user interface 51 can be further configured to store the at least one additional algorithm 30 in the reader memory 53 as desired. Further, the selector module 57 can be configured to select at least one active algorithm 25 from the at least one additional algorithm 30. It is contemplated that the at least one additional algorithm 30 can replace other algorithms in the set 20, or be added into the set 20 without other modification or deletion of pre-existing algorithms in the set 20. It will also be understood that other signal connections or transmissions not explicitly shown are contemplated for use in the authentication system 1.

Referring now to FIG. 3, data or signal communications between various components of the authentication system 1 are schematically illustrated. Dashed arrows indicate two-way signal communication between connected components, including the receipt or transmission of data, commands, control signals, indicators, or the like.

The set of modules 55 is illustrated with the input module 56, the selector module 57, and the comparison module 58 communicatively coupled. It will be understood that signals, data, and the like received by one of the modules 56, 57, 58 can be transmitted or directed to another of the modules 56, 57, 58 as desired. It will be further understood that components illustrated as being in signal communication with the set of modules 55, such as being connected to a border surrounding the modules 56, 57, 58, can communicate with any of the modules in the set 55.

As described above, the RFID tag 10 can transmit the set of algorithms 20, the tag ID 40, or the pseudo-ID 42 to the reader antenna 54 via the signal communication 60 for receipt by the input module 56. In addition, an active algorithm 25, additional algorithm 30, or additional pseudo-ID 43 can also be received by the input module 56 via the user interface 51.

The selector module 57 can receive or send any of the data or items received by the input module 56. In one example, the selector module 57 can select an active algorithm 25 from the set of algorithms 20, and the comparison module 58 can receive the selected active algorithm 25 from the selector module 57. In another example, a user-specified active algorithm 25 received by the input module 56 can be transmitted directly to the comparison module 58.

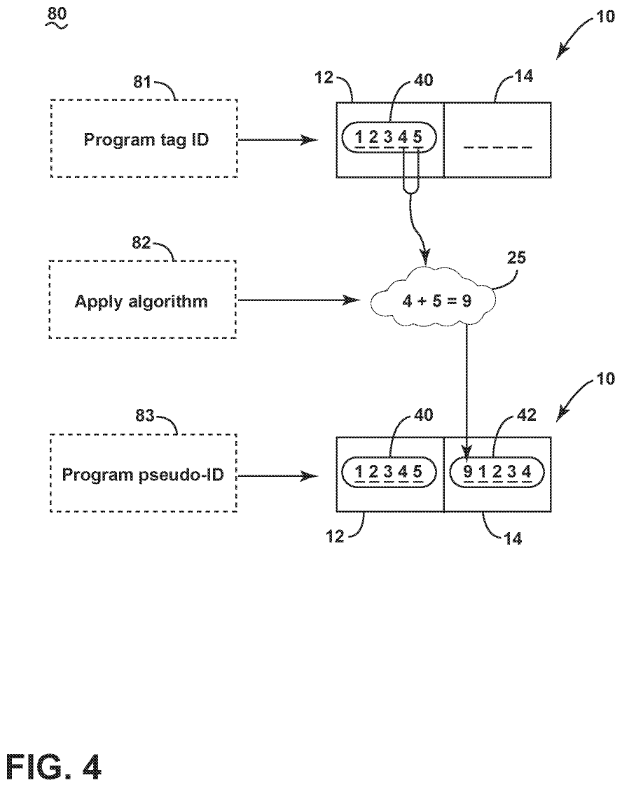

The comparison module 58 can receive, in one example, the tag ID 40, the pseudo-ID 42, and a decoded ID 44 (FIG. 4) for comparison of values. The comparison module 58 can also provide an indication (not shown) of the result of such a comparison, and the indication can be sent to the reader memory 53, the user interface 51, or the RFID tag 10 as desired.

In addition, the reader processor 52 can be utilized by any or all of the modules 56, 57, 58 to access the reader memory 53. For example, values such as the tag ID 40, pseudo-ID 42, or decoded ID 44 can be stored in the reader memory 53 or retrieved from the reader memory 53.

Further, a remote device 70 can be in signal communication with the set of modules 55, or any component of the RFID reader 50 or RFID tag 10. The remote device 70 can include a remote server, a mobile device, an external computer, a secondary processor, an external database, or the like. In one example, the remote device 70 can transmit additional algorithms 30 for use in authenticating the RFID tag 10. In another example, the remote device 70 can transmit an additional pseudo-ID 43 to the RFID tag 10 via the set of modules 55, or transmit the additional pseudo-ID 43 to the reader memory 53.

FIG. 4 illustrates an optional method 80 of programming the pseudo-ID 42 into the exemplary RFID tag 10. At 81 the tag ID 40 can be generated and stored in the non-programmable memory 12, such as during manufacture of the RFID tag 10. For the purposes of illustration, the tag ID 40 is shown as “1 2 3 4 5”. It will be understood that the tag ID 40 can include any number of characters in any desired format, and can include other parameters such as a GPS identifier, timestamp, serial number, image or binary image representation, or expiration date, in non-limiting examples. Furthermore, any algorithm described herein can also account for such other parameters (e.g. GPS identifier, timestamps, and the like) as desired.

At 82, an active algorithm 25 can be applied to the tag ID 40. Applying the active algorithm 25 can be accomplished via a remote device 70 or via the tag processor 15. The active algorithm 25 is illustrated as selecting the last two digits (‘4’ and ‘5’) of the tag ID 40 and adding them together. The summated result (‘9’) forms a selected digit of the pseudo-ID 42. The active algorithm 25, or another algorithm (not shown), can be utilized to also generate the remainder of the pseudo-ID 42. In the illustrated example, the pseudo-ID 42 is shown as “9 1 2 3 4,” wherein the first digit is the summated result of the last two digits of the tag ID 40, and the remaining digits of the pseudo-ID 42 are formed from the remaining digits of the tag ID 40 as shown. At 83, the pseudo-ID 42 can be programmed or stored into the programmable memory 14 of the RFID tag 10. As described above, the pseudo-ID 42 can be stored in the RFID tag 10 during manufacturing of the tag 10, or by a customer manufacturing or distribution center or an end point of sale as desired.

It will be understood that all algorithms described herein are simplified for clarity of understanding, and that the actual algorithm utilized in the set of algorithms 20 or the at least one additional algorithm 30 can include other factors, calculations, or forms.

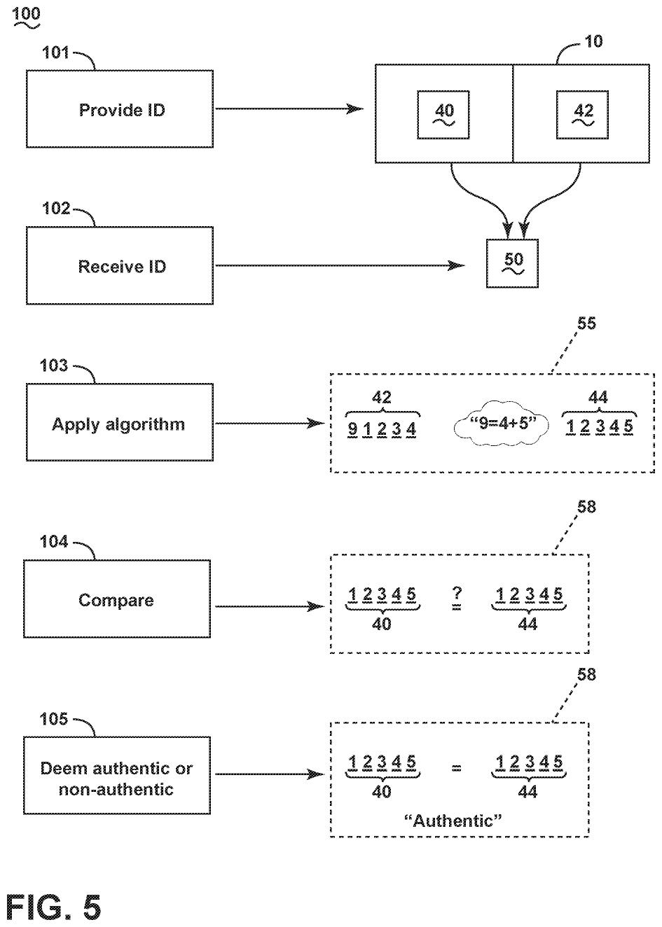

Referring now to FIG. 5, a method 100 of authenticating the RFID tag is shown. It will be understood that the method 100 can be utilized to authenticate a plurality of RFID tags, and that portions of the method 100 can be repeated or performed in any order as desired.

At 101, the RFID tag 10 can be provided having the tag ID 40 and the pseudo-ID 42, wherein the pseudo-ID 42 is related to the tag ID 40 by at least the active algorithm 25 as described above. At 102, the tag ID 40 (e.g. “1 2 3 4 5”) and the pseudo-ID 42 (e.g. “9 1 2 3 4”) can be received in the RFID reader 50, such as via the tag antenna 17 and the reader antenna 54.

At 103, the reader processor 52 can apply at least one algorithm, such as the active algorithm 25, to the tag ID 40 or the pseudo-ID 42 to generate a decoded ID 44. In the illustrated example, the reader processor 52 is shown applying the active algorithm 25 to the pseudo-ID 42 to generate the decoded ID 44. For example, the reader processor 52 can utilize the active algorithm 25 to decode “9=4+5” and generate the decoded ID 44 of “1 2 3 4 5,” with ‘4’ and ‘5’ in the correct position. If the active algorithm 25 also includes information on the remainder of the characters in the pseudo-ID, the reader processor 52 can further utilize the active algorithm 25 to generate the entire decoded ID 44 (e.g. the ‘1,’‘2,’ and ‘3’ in the correct positions).

At 104, the comparison module 58 can compare the decoded ID 44 with the tag ID 40. It is further contemplated that the comparison module 58 can compare the decoded ID with the pseudo-ID 42, such as in an example wherein the reader processor 52 applies the active algorithm 25 to the tag ID 40 to generate the decoded ID 44. If the decoded ID 44 matches the tag ID 40 (or the pseudo-ID 42 as desired), the comparison module 58 can deem the RFID tag 10 as authentic at 105. If the decoded ID 44 does not match the tag ID 40 (or the pseudo-ID 42), the comparison module 58 can deem the RFID tag 10 as not authentic at 105. In addition, the comparison module 58 can be configured to provide an indication (such as via the user interface 51) of the result of the comparison such as “Authentic,” “Non-Authentic,” or other indications as described above.

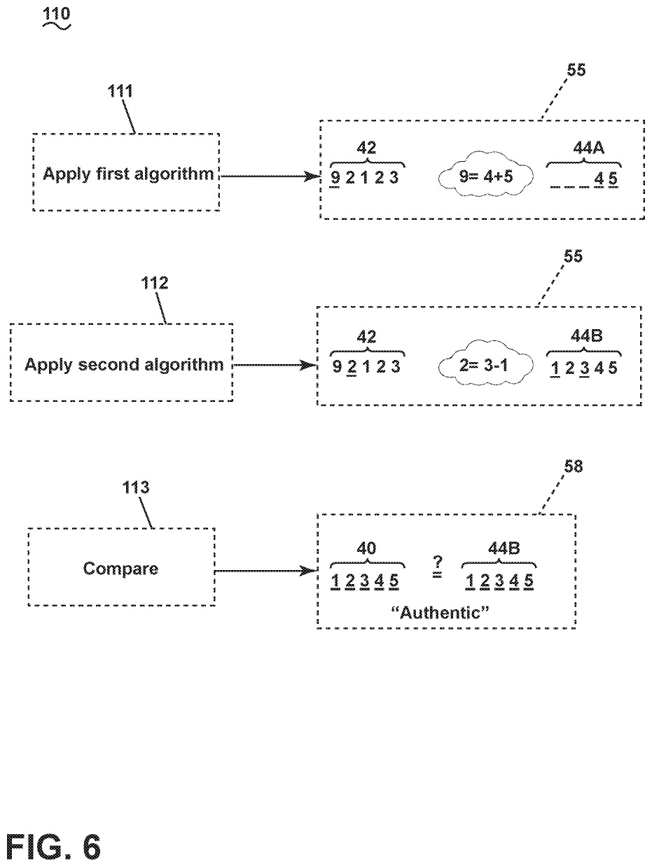

Turning to FIG. 6, another optional method 110 of authenticating an RFID tag 10 is illustrated wherein the tag ID 40 is related to the pseudo-ID 42 by a first algorithm 21 and a second algorithm 22. At 111 the reader processor 52 can apply the first algorithm 21 during a first time period to the tag ID 40 or the pseudo-ID 42; the example of FIG. 6 illustrates the first algorithm 21 being applied to the pseudo-ID 42 of “92123” to generate a first decoded ID 44A of “_ _ _ 4 5”. As described above, the first algorithm 21 can include additional details regarding the remainder of the decoded ID 44A. For clarity, only a portion of the first algorithm 21 is illustrated wherein the final digit of the pseudo-ID 42 is related by summation to the final two digits of the first decoded ID 44A.

At 112 the reader processor 52 can apply the second algorithm 22 during a second time period to generate a second decoded ID 44B. In the illustrated example, the second algorithm 22 is applied to the first decoded ID 44A “_ _ _ 4 5” to generate the second decoded ID 44B of “1 2 3 4 5”. More specifically, the second algorithm 22 is illustrated as relating the pseudo-ID 42 to the tag ID 40 wherein the subtraction of the first and third digits of the tag ID 40 forming the second digit of the pseudo-ID 42. The second algorithm 22 can also include additional details regarding the remainder of the first decoded ID 44A or the second decoded ID 44B. For clarity, such additional details are not expanded upon here and the second decoded ID 44B is illustrated as “1 2 3 4 5”.

It is also contemplated in an alternate example (not shown) that the algorithms 21, 22 can be applied to either of the tag ID 40 or the pseudo-ID 42 separately. For example, the first algorithm 21 can be applied to the pseudo-ID 42 to generate a first decoded ID 44A, and the second algorithm 22 can separately be applied to the pseudo-ID 42 to generate a second decoded ID 44B. In such a case, the first and second decoded IDs 44A, 44B could be processed, merged, or combined to form a final decoded ID (not shown) for comparison with the tag ID 40. In another example, the first and second algorithms 21, 22 can be applied in any order to the pseudo-ID 42 to form a final decoded ID (not shown) for comparison.

At 113, the comparison module 58 can compare the second decoded ID 44B (or a final decoded ID) with the tag ID 40 for authentication of the RFID tag 10. It will also be understood that in an example where the reader processor 52 applies the algorithms 21, 22 to the tag ID 40, the comparison module 58 can compare the second decoded ID 44B (or a final decoded ID) with the pseudo-ID 42 for authentication.

In still another example, the first algorithm 21 alone can be utilized to authenticate the RFID tag 10 during a first time period (e.g. on Tuesdays), while the second algorithm 22 can be utilized alone to authenticate the RFID tag 10 during a second time period (e.g. on Wednesdays). In such a case, the first decoded ID 44A can be compared with the tag ID 40 during the first time period, and the second decoded ID 44B can be compared with the tag ID 40 during the second time period.

The sequences depicted above are for illustrative purposes only and are not meant to limit the methods 80, 100, 110 in any way. It is understood that the portions of the methods 80, 100, 110 can proceed in a different logical order, additional or intervening portions can be included, or described portions of the methods 80, 100, 110 can be divided into multiple portions, or described portions of the method can be omitted without detracting from the described method.

One non-limiting example of the authentication system 1 can be implemented in a product authentication system. A consumer can activate a near-field communication (NFC) payment application (or “app”) on a smart device such as a smartphone, tablet, or watch. The consumer can “tap” or briefly place the smart device within near-field communication range of a product to be purchased. The product can include an NFC tag to be authenticated. Communication can be established between the smart device and the product's NFC tag, and the payment app on the smart device can interrogate the NFC tag for the tag ID and the pseudo-ID. Optionally, the payment app can launch a separate application for product authentication, in which case the tag ID and pseudo-ID can be transmitted to the product authentication app from the payment app. The smart device (e.g. the payment app, or the product authentication app) can process the received tag ID and the pseudo-ID, utilizing at least one algorithm and performing a comparison based on the at least one algorithm to authenticate the product's NFC tag. In the event of a successful comparison wherein the NFC tag is deemed authentic, the payment app can continue with the purchase such as via a mobile wallet or pre-stored payment method on the smart device. In the event of an unsuccessful comparison wherein the NFC tag is deemed inauthentic, the payment app can suspend the purchase. Optionally, the smart device can communicate to the consumer a message indicating that the product's NFC tag is deemed authentic (such as a check mark or sound indication) or inauthentic (such as an ‘X’ or another sound indication).

Another non-limiting example of the authentication system 1 can be implemented in another product authentication system in a shipping center. Products containing RFID tags can be placed on a conveyer belt and directed to a stationary RFID reader positioned adjacent, or over, the conveyer belt. As each product moves within communication range of the stationary RFID reader, communication can be established between that product's RFID tag and the RFID reader. The stationary reader can receive a tag ID and a pseudo-ID from each RFID tag, and perform a comparison based on at least one algorithm. Upon successful authentication of a product's RFID tag, the conveyer belt can continue to move the product for processing or shipping. If a product's RFID tag is deemed inauthentic, the conveyer belt can stop while the product is removed. Alternately, product with authenticated RFID tags can be directed from the stationary RFID reader via a first conveyer belt for standard processing or shipping, and products with RFID tags deemed inauthentic can be directed from the RFID reader via a second conveyer belt for further analysis.

Yet another non-limiting example of the authentication system 1 can be implemented in a medical setting. Pre-sterilized medical products can be individually packaged with an RFID tag, either within the sterilized package or coupled to an exterior of the package. A box or container having a batch of such pre-sterilized medical products can be brought within communication range of an RFID reader configured to communicate with a plurality of RFID tags simultaneously. The RFID reader can receive each tag ID and pseudo-ID from each pre-sterilized medical product in the container, and perform a comparison based on at least one algorithm to authenticate each product's RFID tag. In the event that every product's RFID tag within the container is deemed authentic, the RFID reader can provide an indication such as “Container OK” or play an audio message indicating the same. If at least one medical product's RFID tag is deemed inauthentic by the RFID reader, the reader can provide an indication such as “Error: Inauthentic Product,” or indicate a number of tags within the container deemed inauthentic by the reader.

Many other possible aspects and configurations in addition to that shown in the above figures are contemplated by the present disclosure. Additionally, the design and placement of the various components can be rearranged such that a number of different configurations could be realized.

Aspects of the present disclosure provide for a variety of benefits, including an authentication system that ensures that the tag ID of a given RFID tag is correct and not simply a duplication or clone of an existing tag. A technical effect is that the use of shared algorithms between the RFID reader and RFID tag provide for varying levels of security without need of an internet connection or a separate connection between the RFID reader and a remote device. The above described aspects enable a simplified system for authentication of an RFID tag by way of a single RFID reader. The algorithms utilized to relate the tag ID and pseudo-ID can be refreshed, updated, or combined to provide for a secure method of authenticating an RFID tag while reducing the complexity of the RFID authentication system compared to systems needing an Internet connection or a signal connection to an external server.

In addition, the above-described aspects have a technical effect of providing for a more efficient authentication process by reducing a transmission or “lookup” time compared to traditional systems that query an external server or database to verify an RFID tag. It can be appreciated that such a quick, de-centralized authentication is more efficient than traditional systems while preserving security measures to prevent undesirable duplication, cloning, or counterfeiting of verified RFID tags. Additional inputs can be utilized as security measures including geographical locations. In addition, information typically transmitted as part of a smartphone cellular connection can form such additional inputs. For example, if an end user authenticates the product via a smartphone, the end user's approximate location can be provided and utilized when compared to the location where the product was shipped. This can have the benefit of informing the brand owner to know that even authenticated products may have been diverted to an unauthorized location, such as a country not authorized for trade by the local government. This allows for a higher level of security and authentication to be achieved, including in the absence of an interne or cellular connection.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

For example, it is contemplated that combinations or permutations of features may include the following:
A method for authenticating a radio frequency identification (RFID) tag, the method comprising:

providing an RFID tag having a tag ID and a pseudo-ID, wherein the pseudo-ID is related to the tag ID by at least one algorithm in a set of algorithms;
receiving, in an RFID reader, the tag ID and the pseudo-ID from the RFID tag;
applying, via a processor in the RFID reader, at least one algorithm of the set of algorithms to one of the tag ID and the pseudo-ID to generate a decoded ID;
comparing, in the RFID reader, the decoded ID with the one of the tag ID and the pseudo-ID; and

if the decoded ID matches the one of the tag ID and the pseudo-ID, then deeming the RFID tag as authentic, and if the decoded ID does not match the one of the tag ID and the pseudo-ID, then deeming the RFID tag as not authentic.

The foregoing method wherein the pseudo-ID is related to the tag ID by each algorithm in the set of algorithms.

A method according to any of the foregoing methods wherein the applying further comprises applying each algorithm in the set of algorithms to the one of the tag ID and the pseudo-ID to generate the decoded ID.

A method according to any of the foregoing methods further comprising selecting at least one active algorithm from the set of algorithms, and wherein the applying further comprises applying the selected at least one active algorithm to the one of the tag ID and the pseudo-ID to generate the decoded ID.

A method according to any of the foregoing methods further comprising storing the tag ID in a non-programmable memory of the RFID tag, and storing the pseudo-ID in a programmable memory of the RFID tag.

A method according to any of the foregoing methods further comprising generating an additional pseudo-ID for the RFID tag based on an additional set of algorithms, and storing the additional pseudo-ID in the programmable memory of the RFID tag.

A method according to any of the foregoing methods wherein the applying further comprises applying at least one additional algorithm from the additional set of algorithms to the one of the tag ID and the pseudo-ID to generate the decoded ID.

A method according to any of the foregoing methods wherein the set of algorithms comprises at least one of a check digit, a key, a random number generator, a bit flipping function, or a checksum function.

A method according to any of the foregoing methods further comprising comparing, during a first time period, the one of the tag ID and the pseudo-ID with a first decoded ID generated by a first algorithm and comparing, during a second time period, the one of the tag ID and the pseudo-ID with a second decoded ID generated by a second algorithm.

A method according to any of the foregoing methods further comprising deeming the RFID tag as authentic if both the first decoded ID and the second decoded ID match the one of the tag ID and the pseudo-ID.

A system for authenticating a radio frequency identification (RFID) tag having a programmable memory and a non-programmable memory, comprising:

a tag ID stored in the non-programmable memory;

a pseudo-ID stored in the programmable memory, wherein the pseudo-ID is related to the tag ID by a set of algorithms; and

an RFID reader comprising:
a memory;
the set of algorithms stored in the memory;
an input module configured to receive the tag ID and the pseudo-ID from the RFID tag;
a processor configured to generate a decoded ID via the set of algorithms; and
a comparison module configured to compare the decoded ID with one of the tag ID and the pseudo-ID.

A system according to the foregoing system further configured to determine the RFID tag as authentic when the decoded ID matches the one of the tag ID and the pseudo-ID in a comparison.

A system according to any of the foregoing systems wherein the pseudo-ID is related to the tag ID by each algorithm in the set of algorithms.

A system according to any of the foregoing systems wherein the processor is further configured to generate an additional pseudo-ID and store the additional pseudo-ID in the programmable memory.

A system according to any of the foregoing systems further comprising a selector module configured to select at least one active algorithm from the set of algorithms in the memory.

A system according to any of the foregoing systems further comprising a user interface configured to receive at least one additional algorithm.

A system according to any of the foregoing systems wherein the user interface is further configured to store the at least one additional algorithm in the memory.

A system according to any of the foregoing systems wherein the selector module is further configured to select the at least one active algorithm from the at least one additional algorithm.

A system according to any of the foregoing systems wherein at least one of the user interface and the selector module is located in one of the RFID reader or a remote device in signal communication with the RFID reader.

A system according to any of the foregoing systems wherein the processor is configured to apply the at least one active algorithm to the one of the tag ID and the pseudo-ID to generate the decoded ID.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for authenticating a radio frequency identification (RFID) tag, the method comprising:
providing an RE ID tag having a tag ID and a pseudo-ID, wherein the pseudo-ID is related to the tag ID by at least one algorithm in a set of algorithms;
receiving, in an RFID reader, the tag ID and the pseudo-ID from the RFID tag);
applying, via a processor in the RFID reader, at least one algorithm of the set of algorithms to one of the tag ID and the pseudo-ID to generate a decoded ID;
comparing, in the RFID reader, the decoded ID with the one of the tag ID and the pseudo-ID; and
if the decoded ID matches the one of the tag ID and the pseudo-ID, then deeming the RFID tag as authentic, and if the decoded ID does not match the one of the tag ID and the pseudo-ID, then deeming the RFID tag as not authentic.

2. The method of claim 1 wherein the pseudo-ID is related to the tag ID by each algorithm in the set of algorithms.

3. The method of claim 2 wherein the applying further comprises applying each algorithm in the set of algorithms to the one of the tag ID and the pseudo-ID to generate the decoded ID.

4. The method of claim 3 further comprising selecting at least one active algorithm from the set of algorithms, and wherein the applying further comprises applying the selected at least one active algorithm to the one of the tag and the pseudo-ID to generate the decoded ID.

5. The method of claim 1 further comprising storing the tag ID in a non-programmable memory of the RFID tag, and storing the pseudo-ID in a programmable memory of the RFID tag.

6. The method of claim 5 further comprising generating an additional pseudo-ID for the RFID tag based on at least one additional algorithm, and storing the additional pseudo-ID in the programmable memory of the RFID tag.

7. The method of claim 6 wherein the applying further comprises applying the at least one additional algorithm to the one of the tag ID and the pseudo-ID to generate the decoded ID.

8. The method of claim 1 wherein the set of algorithms comprises at least one of a check digit, a key, a random number generator, a bit flipping function, or a checksum function.

9. The method of claim 1 further comprising comparing, during a first time period, the one of the tag ID and the pseudo-ID with a first decoded ID generated by a first algorithm) and comparing, during a second time period, the one of the tag ID and the pseudo-ID with a second decoded ID generated by a second algorithm.

110. The method of claim 9 further comprising deeming the RFD tag as authentic if both the first decoded ID and the second decoded ID match the one of the tag ID and the pseudo-ID.
